(19) United States
(12) Patent Application Publication
(10) Pub. No.: US 2022/0219380 A1
(43) Pub. Date: Jul. 14, 2022

(54) DEPOSITING THERMOSETTING MATERIAL ON A THREE DIMENSIONAL OBJECT

(71) Applicant: CHROMATIC 3D MATERIALS INC., Golden Valley, MN (US)

(72) Inventors: Cora LEIBIG, Maple Grove, MN (US); Michael GARROD, Minnetrista, MN (US)

(21) Appl. No.: 17/613,920

(22) PCT Filed: May 22, 2020
(86) PCT No.: PCT/US2020/034181

§ 371 Date: Nov. 23, 2021

Related U.S. Application Data
(60) Provisional application No. 62/851,902, filed on May 23, 2019.

(51) Int. Cl. B29C 64/106; B32B 5/20; B33Y 10/00; B33Y 70/00; B33Y 80/00

(52) U.S. Cl. CPC B29C 64/106; B32B 5/20; B29K 2101/10; B33Y 70/00; B33Y 80/00; B33Y 10/00

(57) ABSTRACT

A method for additive manufacturing, comprising depositing at least one layer of a thermosetting material on an exterior of at least one prefabricated article. A 3D printed object comprising an exterior containing a thermoset material and an interior containing a prefabricated article.

### FIELD

The present disclosure relates to methods for 3D additive manufacturing and methods for printing on an exterior of a 3D object. The application also relates to a 3D object prepared by 3D additive manufacturing.

### BACKGROUND

Fused filament fabrication (FFF), also referred to in the art as thermoplastic extrusion, plastic jet printing (PJP), fused filament method (FFM), or fusion deposition modeling, is an additive manufacturing process wherein a material is extruded in successive layers onto a platform to form a 3-dimensional (3D) product. Typically, FFF uses a melted thermoplastic material that is extruded onto a platform. Three-dimensional printing (3D printing) sometimes uses support structures that are easily dissolved or removed from the part after printing.

Disadvantages of existing FFF technology using thermoplastics include single material property printing, limited print-direction strength, limited durability, and limited softness. Thermosetting materials have generally not been used in FFF because prior to cure, the monomers are low viscosity liquids, and upon deposition, the curing liquid flows or breaks into droplets, resulting in finished parts of low quality and undesirably low resolution. Attempts to print with thermoset materials has required addition of fillers (such as inorganic powders or polymers) to induce thixotropic behavior in the resin before it is fully cured. These solutions adversely affect the final properties of the printed part. Other problems include poor resolution control in the printed part and frequent clogging of mixing systems.

### SUMMARY

The present disclosure is related to 3D printing methods and 3D printed objects.

In certain embodiments, the present disclosure is directed to a method for additive manufacturing method, comprising depositing at least one layer of a thermosetting material on an exterior of at least one prefabricated article.

In certain embodiments, the disclosure is directed to a method for additive manufacturing, comprising: depositing at least one layer of a thermosetting material on an exterior of at least one prefabricated article.

In certain embodiments, the method comprises depositing at least one layer of material in a predefined pattern.

In certain embodiments, the method comprises depositing the at least one layer of material on at least about 10% of the exterior of the prefabricated article. In certain embodiments, the method comprises depositing at least one layer of material on at least about 25% of the exterior of the prefabricated article. In certain embodiments, the method comprises depositing at least one layer of material on at least about 50% of the exterior of the prefabricated article. In certain embodiments, the method comprises depositing at least one layer of material on at least about 75% of the exterior of the prefabricated article. In certain embodiments, the method comprises depositing at least one layer of material on about 100% of the exterior of the prefabricated article.

In certain embodiments, the method comprises depositing at least two layers of material on the exterior of the prefabricated article. In certain embodiments, the method comprises depositing at least three layers of material on the exterior of the prefabricated article.

In certain embodiments, the method comprises first depositing at least one layer of a thermosetting material on a portion of the exterior of the least one prefabricated article, stopping the depositing of the thermosetting material for a time, and subsequently depositing at least one layer of a thermosetting material on an exterior of the least one prefabricated article. In certain embodiments, the subsequent depositing is on a portion of the exterior where no first depositing was performed. In certain embodiments, the subsequent depositing is on a portion of the exterior where first depositing was performed.

In certain embodiments, the at least one prefabricated article comprises a polyhedron, a sphere, a tetrahedron, a triangular prism, a cylinder, a cone, a pyramid, a cuboid, a cube, an octahedron, a smooth shape, and an irregular shape.

In certain embodiments, the at least one prefabricated article comprises electronics or a circuit board.

In certain embodiments, the thermosetting material comprises an isocyanate, an isocyanate prepolymer, a urethane, a urea-containing polymer, a polyol prepolymer, an amine prepolymer, a polyol containing at least one terminal hydroxyl group, a polyamine containing at least one amine that contains an isocyanate reactive hydrogen, or mixtures thereof.

In certain embodiments, the thermosetting material comprises at least two reactive components. In certain embodiments, the thermosetting material comprises at least three reactive components.

In certain embodiments, the thermosetting material comprises a solid thermosetting material. In certain embodiments, the thermosetting material comprises a foam thermosetting material. In certain embodiments, the thermosetting material comprises a solid thermosetting material and a foam thermosetting material.

In certain embodiments, the prefabricated article comprises a thermoplastic, a metal, a thermoset, a ceramic, a wood, a composite, a carbon fiber, a Kevlar, a glass, and mixtures thereof.

In certain embodiments, the prefabricated article comprises electronic components or electronic assemblies. In certain embodiments, the prefabricated article comprises optoelectronic components or optoelectronic assemblies.

In certain embodiments, there can be a bond between the thermosetting material and the prefabricated article. In certain embodiments, the bond is an adhesive bond, a cohesive bond, a geometric bond, or a chemical bond.

In certain embodiments, the method comprises a peel strength between the thermosetting material and the prefabricated article. In certain embodiments, the peel strength is about 1 N/mm to about 20 N/mm.

In certain embodiments, the method comprises depositing the at least one layer of thermosetting material using a pick and place assembly.

In certain embodiments, the method comprises a control system operably coupled to a printing apparatus. In certain embodiments, the control system comprises one or more processors.

In certain embodiments, the method comprises one or more sensors. In certain embodiments, the one or more sensors detect the location of the prefabricated article. In certain embodiments, the one or more sensors detect the location of the prefabricated article and optimize the depositing of the at least one layer of thermosetting material based on the shape and location of the prefabricated article.

In certain embodiments, the method comprises optimizing the depositing of the at least one layer of thermosetting material based on the shape and location of the prefabricated article.

In certain embodiments, the method comprises picking up the prefabricated article from a location before the depositing and moving the prefabricated art to a different location for the depositing. In certain embodiments, the method comprises picking up the prefabricated article with a robotic apparatus or a jig.

In certain embodiments, the disclosure is directed to a 3D printed article prepared according to the disclosed methods.

In certain embodiments, the disclosure is directed to a 3D printed object comprising an exterior containing a thermoset material and an interior containing a prefabricated article.

In certain embodiments, about 10% of an exterior of the prefabricated article contains thermoset material. In certain embodiments, about 25% of an exterior of the prefabricated article contains thermoset material. In certain embodiments, about 50% of an exterior of the prefabricated article contains thermoset material. In certain embodiments, about 75% of an exterior of the prefabricated article contains thermoset material. In certain embodiments, about 100% of an exterior of the prefabricated article contains thermoset material.

In certain embodiments, the 3D printed object comprises a bond between the exterior containing a thermoset material and the interior containing the prefabricated article.

In certain embodiments of the 3D printed object, the bond is an adhesive bond, a cohesive bond, a geometric bond, or a chemical bond.

It is to be understood that both the Summary and the Detailed Description are exemplary and explanatory only, and are not restrictive of the disclosure as claimed.

### BRIEF DESCRIPTION OF THE FIGURES

FIG. 1 depicts depositing a thermosetting material on an exterior a prefabricated article.

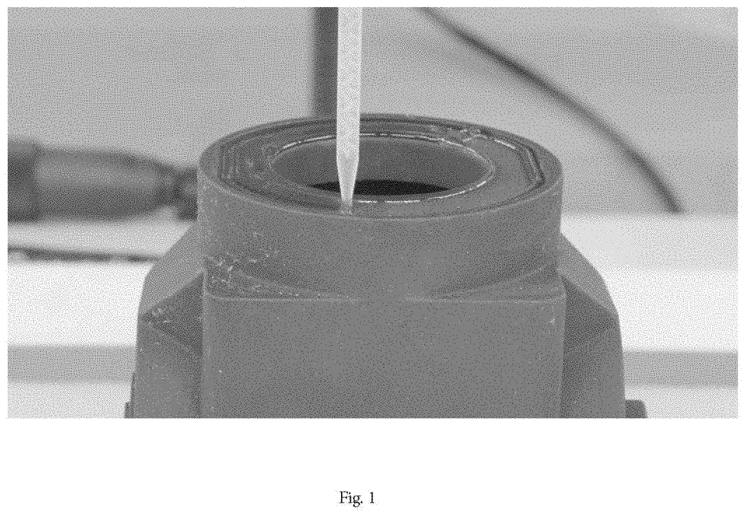

FIG. 2 depicts force data for polyurethane 3D printed on different substrates.

FIG. 3 depicts peel strength data for polyurethane 3D printed on different substrates.

### DETAILED DESCRIPTION

Embodiments of the disclosure relate to methods for 3D additive manufacturing and methods for printing on an exterior of a prefabricated article. The application also relates to a 3D object prepared by 3D additive manufacturing. It has been surprisingly and unexpectedly found that thermosetting material can be printed on an exterior of a prefabricated 3D article. By following the present disclosure, a thermosetting material can be printed on an exterior of a prefabricated article, creating a strong bond between the thermosetting material and the exterior of the prefabricated article. The resulting 3D printed object can be a new 3D printed object, which comprises the prefabricated article interior and a thermoset exterior.

The present disclosure provides for customization using a prefabricated part. In certain embodiments, the present disclosure provides for customization of footwear, seating, apparel, or any other article where customization of a prefabricated article is desired.

Various examples and embodiments of the subject matter disclosed are possible and will be apparent to a person of ordinary skill in the art, given the benefit of this disclosure. In this disclosure reference to “some embodiments,” “certain embodiments,” “certain exemplary embodiments” and similar phrases each means that those embodiments are non-limiting examples of the inventive subject matter, and there may be alternative embodiments which are not excluded.

The articles “a,” “an,” and “the” are used herein to refer to one or more than one (i.e., to at least one) of the grammatical object of the article. By way of example, “an element” means one element or more than one element.

As used herein, the term “about” means±10% of the noted value. By way of example only, at least one layer of material on at least “about 50% of the exterior” of the prefabricated article could include from at least 45% of the exterior up to and including at least 55% of the exterior.

The word “comprising” is used in a manner consistent with its open-ended meaning, that is, to mean that a given product or process can optionally also have additional features or elements beyond those expressly described. It is understood that wherever embodiments are described with the language “comprising,” otherwise analogous embodiments described in terms of “consisting of” and/or “consisting essentially of” are also contemplated and within the scope of this disclosure.

As used herein, the term “additive manufacturing” means extruded printing of thermosetting material.

As used herein, the term “bond” means any interaction between two substrates that improves adhesion, binding, interaction, and/or interconnectivity between the substrates. In certain embodiments, the bond can be an adhesive bond, a cohesive bond, a geometric bond, or a chemical bond. In certain embodiments, an adhesive bond can be a bond between two substrates, optionally with the addition of an adhesive between the substrates, where adhesive failure results in adhesive remaining on one substrate and not remaining on the other substrate. In certain embodiments, a cohesive bond can be a bond between two substrates, optionally with the addition of an adhesive between the substrates, where cohesive failure results in adhesive remaining on both substrates. In certain embodiments, geometric bonding can be a bond between two substrates, optionally with the addition of an adhesive between the substrates, where the viscosity, extent of cure, or any other property allows for flush bonding between the substrates, even if the substrates are of irregular shape or are different in shape. In certain embodiments, chemical bonding can be a lasting chemical attraction between atoms, ions, or molecules.

As used herein, an “exterior” of a prefabricated article means at least a portion of the exposed outermost portion of the prefabricated article, any portion of a side or the sides of the prefabricated article, anywhere on the prefabricated article that could be exposed to air or liquid in a chamber, and any outer portion of the prefabricated article. The exterior can be of regular shape, irregular shape, complex shape, have sides of equal dimension, have sides of unequal dimension, and includes cavities, gaps, or holes in the prefabricated article.

As used herein, the terms “thermoset,” “thermoset product,” and “thermoset material” are used interchangeably and refer to the reaction product of at least two chemicals which form a covalently bonded crosslinked or polymeric network. In contrast to thermoplastics, a thermoset product described herein can irreversibly solidify or set.

As used herein, the term “thermosetting material” refers to a covalently bonded crosslinked or polymeric network that is still reactive, e.g., it can still have hydroxyl, amine, and/or isocyanate functionality that gives a measureable hydroxyl number, NH number, or NCO number in a titration. In one embodiment, a thermosetting material can have a viscosity below 3,000,000 cp. In one embodiment, thermosetting material can have a molecular weight of no greater than 100,000 g/mol.

Method for Additive Manufacturing

In certain embodiments, the present disclosure relates to method for additive manufacturing, comprising depositing at least one layer of a thermosetting material on an exterior of at least one prefabricated article.

In certain embodiments, the method comprises depositing at least one layer of material in a predefined pattern.

In certain embodiments, the method comprises depositing at least one layer of material on at least a portion of the exterior of the prefabricated article.

In certain embodiments, the depositing of at least one layer of material can be on at least about 10% of the exterior of the prefabricated article. In certain embodiments, the depositing of at least one layer of material can be on at least about 25% of the exterior of the prefabricated article. In certain embodiments, the depositing of at least one layer of material can be on at least about 50% of the exterior of the prefabricated article. In certain embodiments, the depositing of at least one layer of material can be on at least about 75% of the exterior of the prefabricated article. In certain embodiments, the depositing of at least one layer of material can be on about 100% of the exterior of the prefabricated article.

In certain embodiments, the depositing of at least one layer of material can be on from about 5% to about 95% of the exterior of the prefabricated article. In certain embodiments, the depositing of at least one layer of material can be on from about 10% to about 90% of the exterior of the prefabricated article. In certain embodiments, the depositing of at least one layer of material can be on from about 25% to about 75% of the exterior of the prefabricated article. In certain embodiments, the depositing of at least one layer of material can be on from about 50% to about 95% of the exterior of the prefabricated article. In certain embodiments, the depositing of at least one layer of material can be on from about 60% to about 95% of the exterior of the prefabricated article. In certain embodiments, the depositing of at least one layer of material can be on from about 70% to about 95% of the exterior of the prefabricated article. In certain embodiments, the depositing can be on about 100% of the prefabricated article.

In certain embodiments, the depositing of at least one layer of material can be on at least about 1%, about 5%+, about 10%+, about 15%, about 20%, about 25%, about 30%, about 35%, about 40%+, about 45%, about 50%, about 55%, about 60%, about 65%, about 70%, about 75%+, about 80%, about 85%, about 90%, about 95%, about 99%, or any ranges between the specified values of the exterior of the prefabricated article.

In certain embodiments, the method comprises depositing at least one layer of a thermosetting material on an exterior of at least one prefabricated article. In certain embodiments, the method comprises depositing at least two layers on the exterior of the prefabricated article. In certain embodiments, the method comprises depositing at least three layers on the exterior of the prefabricated article. The number of layers to be deposited is not particularly limited. In certain embodiments, the number of layers to be deposited can be 1, 2, 3, 4, 5, 6, 7, 8, 9, 10, or any ranges between the specified values.

In certain embodiments, the method comprises first depositing at least one layer of a thermosetting material on a portion of the exterior of the least one prefabricated article, stopping the depositing of the thermosetting material for a time, and subsequently depositing at least one layer of a thermosetting material on an exterior of the least one prefabricated article.

The time of the stopping between the first depositing and the subsequent depositing is not particularly limited. In certain embodiments, the time of the stopping between the first depositing and the subsequent depositing can be about 1 second, about 5 seconds, about 30 seconds, about 60 seconds, about 2 minutes, about 3 minutes, about 4 minutes, about 5 minutes, about 10 minutes, about 20 minutes, about 30 minutes, about 40 minutes, about 50 minutes, about 1 hour, about 2 hours, about 3 hours, about 6 hours, about 12 hours, about 18 hours, about 24 hours, about 36 hours, about 2 days, or any ranges between the specified values.

In certain embodiments, the subsequent depositing can be on a portion of the exterior where no first depositing was performed. In certain embodiments, the subsequent depositing can be on a portion of the exterior where first depositing was performed.

In certain embodiments, the method comprises optimizing the depositing of the at least one layer of thermosetting material based on the shape and location of the prefabricated article.

In certain embodiments, the method comprises picking up the prefabricated article from a location before the depositing and moving the prefabricated art to a different location for the depositing. In certain embodiments, the picking up the prefabricated article can be achieved by a robotic apparatus, a pick and place apparatus, a jig apparatus, or placing by hand. In certain embodiments, the system utilizes calibration, registration, and/or sensors to guide, direct, or calibrate the picking up and moving of the prefabricated article.

In certain embodiments, the present disclosure relates to a 3D printed article prepared to the methods disclosed herein.

In certain embodiments, the present disclosure relates to a 3D printed object comprising an exterior containing a thermoset material and an interior containing a prefabricated article.

In certain embodiments of the 3D printed object, a thermoset material is on at least a portion of an exterior of a prefabricated article.

In certain embodiments of the 3D printed object, a thermoset material can be on from about 5% to about 95% of the exterior of the prefabricated article. In certain embodiments, the thermoset material can be on from about 10% to about 90% of the exterior of the prefabricated article. In certain embodiments, the thermoset material can be on from about 25% to about 75% of the exterior of the prefabricated article. In certain embodiments, the thermoset material can be on from about 50% to about 95% of the exterior of the prefabricated article. In certain embodiments, the thermoset material can be on from about 60% to about 95% of the exterior of the prefabricated article. In certain embodiments, the thermoset material can be on from about 70% to about 95% of the exterior of the prefabricated article. In certain embodiments, the thermoset material can be on about 100% of the exterior of the prefabricated article.

In certain embodiments of the 3D printed object, the thermoset material can be on at least about 1%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, about 99%, or any ranges between the specified values of the exterior of the prefabricated article. In certain embodiments of the 3D printed object, the thermoset material can be on about 100% of the exterior of the prefabricated article.

In certain embodiments of the 3D printed object, the 3D printed object can have a bond between the exterior containing a thermoset material and the interior containing the prefabricated article. In certain embodiments, the bond can be an adhesive bond, a cohesive bond, a geometric bond, or a chemical bond.

In certain embodiments of the 3D printed object, the 3D printed object can have a peel strength between the thermosetting material and the prefabricated article. In certain embodiments, the peel strength can be from about 1 N/mm to about 20 N/mm. In certain embodiments, the peel strength can be from about 8 N/mm to about 20 N/mm. In certain embodiments, the peel strength can be about 1 N/mm to about 8 N/mm.

In certain embodiments, the method comprises depositing at least one layer of a thermosetting material, placing a prefabricated article on the at least one layer of deposited thermosetting material, and depositing at least one layer of thermosetting material on an exterior of the prefabricated article. In certain embodiments, the placing of the prefabricated article is by a pick and place method. In certain embodiments, the disclosure provides a 3D printed object printed by a method comprising depositing at least one layer of a thermosetting material, placing a prefabricated article on the at least one layer of deposited thermosetting material, and depositing at least one layer of thermosetting material on an exterior of the prefabricated article.

In certain embodiments, a pretreatment can be performed before depositing at least one layer of a thermosetting material on an exterior of an at least one prefabricated article. In certain embodiments, a material can be added onto an exterior of the prefabricated article before depositing at least one layer of a thermosetting material on the exterior of the at least one prefabricated article. In certain embodiments, this material can be a primer, a paint, an adhesion promoter, or a cleaner. In certain embodiments, this material can improve the peel strength between the thermosetting material and the prefabricated article. In certain embodiments, no pretreatment is performed.

In certain embodiments, the pretreatment can be one or more of etching, acid etching, plasma etching, treatment with a chemically active solution, anodization, flame treatment, corona discharge, plasma treatment, atmospheric-pressure plasma treatment, low-pressure plasma treatment, blown arc plasma treatment, chamber plasma treatment, scraping, brushing, blasting, grinding, sandblasting, tumbling, pickling, abrading, power washing, electrodeposition coating, combustion chemical vapor deposition, passivation, coating, laser pretreatment, TV treatment, UV ozone treatment, fluorooxidation, oxidation, and conversion coating.

In certain embodiments, the pretreatment can be one or more of flame treatment, corona discharge, plasma treatment, plasma etching, brushing, sandblasting, and coating. In certain embodiments, the pretreatment can be flame treatment. In certain embodiments, the pretreatment can be corona discharge. In certain embodiments, the pretreatment can be plasma treatment. In certain embodiments, the pretreatment can be plasma etching. In certain embodiments, the pretreatment can be brushing. In certain embodiments, the pretreatment can be sandblasting. In certain embodiments, the pretreatment can be coating.

In certain embodiments, the 3D printed object can be or can be a component of footwear, a gasket, a vehicle part, a robotic part, a prosthetic, or an electronic.

Thermosetting Material

The thermosetting material according to embodiments of the claims can be composed of any number of materials.

In certain embodiments, the thermosetting material can be an isocyanate, an isocyanate prepolymer, a urethane, a urea-containing polymer, a polyol prepolymer, an amine prepolymer, a polyol containing at least one terminal hydroxyl group, a polyamine containing at least one amine that contains an isocyanate reactive hydrogen, or mixtures thereof.

In certain embodiments, the thermosetting material can be an isocyanate. In certain embodiments, the thermosetting material can be an isocyanate prepolymer. In certain embodiments, the thermosetting material can be a urethane. In certain embodiments, the thermosetting material can be a urea-containing polymer. In certain embodiments, the thermosetting material can be a polyol prepolymer. In certain embodiments, the thermosetting material can be an amine prepolymer. In certain embodiments, the thermosetting material can be a polyol containing at least one terminal hydroxyl group. In certain embodiments, the thermosetting material can be a polyamine containing at least one amine that contains an isocyanate reactive hydrogen.

In certain embodiments, the thermosetting material can be a urethane and/or urea-containing polymer. In certain embodiments, a urethane and/or urea-containing polymer can be a polymer which contains urethane groups (—NH—(C═O)—O—) as part of the polymer chain. The urethane linkage can be formed by reacting isocyanate groups (—N═C═O) with hydroxyl groups (—OH). A polyurethane can be produced by the reaction of an isocyanate containing at least two isocyanate groups per molecule with a compound having terminal hydroxyl groups. In certain embodiments, an isocyanate having, on average, two isocyanate groups per molecule can be reacted with a compound having, on average, at least two terminal hydroxyl groups per molecule.

In certain embodiments, a urethane and/or urea-containing polymer can be a polymer which contains urea groups (—NH—(C═O)—NH—) as part of the polymer chain. A urea linkage can be formed by reacting isocyanate groups (—N═C══O) with amine groups (e.g., —N(R′)₂), where each R′ is independently hydrogen or an aliphatic and/or cyclic group (typically a (C₁-C₄)alkyl group)). A polyurea can be produced by the reaction of an isocyanate containing at least two isocyanate groups per molecule with a compound having terminal amine groups.

In certain embodiments, an aliphatic group can be a saturated or unsaturated linear or branched hydrocarbon group. This term can encompass alkyl (e.g., —CH₃) (or alkylene if within a chain such as —CH₂—), alkenyl (or alkenylene if within a chain), and alkynyl (or alkynylene if within a chain) groups, for example. In certain embodiments an alkyl group can be a saturated linear or branched hydrocarbon group including, for example, methyl, ethyl, isopropyl, t-butyl, heptyl, dodecyl, octadecyl, amyl, 2-ethylhexyl, and the like. In certain embodiments, an alkenyl group can be an unsaturated, linear or branched hydrocarbon group with one or more carbon-carbon double bonds, such as a vinyl group. In certain embodiments, an alkynyl group can be an unsaturated, linear or branched hydrocarbon group with one or more carbon-carbon triple bonds. Unless otherwise indicated, an aliphatic group typically contains from 1 to 30 carbon atoms. In certain embodiments, the aliphatic group can contain 1 to 20 carbon atoms, 1 to 10 carbon atoms, 1 to 6 carbon atoms, 1 to 4 carbon atoms, or 1 to 3 carbon atoms.

In certain embodiments, a cyclic group can be a closed ring hydrocarbon group that is classified as an alicyclic group, aromatic group, or heterocyclic group, and can optionally include an aliphatic group. In certain embodiments, an alicyclic group can be a cyclic hydrocarbon group having properties resembling those of aliphatic groups. In certain embodiments, an aromatic group or aryl group can be a mono- or polynuclear aromatic hydrocarbon group. In certain embodiments, a heterocyclic group can be a closed ring hydrocarbon in which one or more of the atoms in the ring is an element other than carbon (e.g., nitrogen, oxygen, sulfur, etc.). Unless otherwise specified, a cyclic group can have 6 to 20 carbon atoms, 6 to 18 carbon atoms, 6 to 16 carbon atoms, 6 to 12 carbon atoms, or 6 to 10 carbon atoms.

In certain embodiments, a urethane and/or urea-containing polymer can be a polymer that contains both urethane and urea groups as part of the polymer chain. A polyurethane/polyurea can be produced by the reaction of an isocyanate containing at least two isocyanate groups per molecule with a compound having terminal hydroxyl groups and a compound having terminal amine groups. In certain embodiments, a polyurethane/polyurea can be produced by the reaction of an isocyanate containing at least two isocyanate groups per molecule with a compound having terminal hydroxyl groups and terminal amine groups (e.g., a hydroxyl-amine such as 3-hydroxy-n-butylamine (CAS 114963-62-1)). A reaction to make a polyurethane, a polyurea, or a polyurethane/polyurea can include other additives, including but not limited to, a catalyst, a chain extender, a curing agent, a surfactant, a pigment, or a combination thereof.

An isocyanate, which can be considered a polyisocyanate, can have the structure R—(N═C═O)ₙ, where n can be at least 2, at least 3, at least 4, at least 5, at least 6, at least 7, or at least 8, and where R can be an aliphatic and/or cyclic group. In certain embodiments, an isocyanate can have an n that is equivalent to n in methylene diphenyl diisocyanate (MDI). In certain embodiments, the isocyanate can be a di-isocyanate (e.g., R—(N═C═O)₂ or (O═C═N)—R—(N═C═O)).

Examples of isocyanates can include, but are not limited to, methylene diphenyl diisocyanate (MDI) and toluene diisocyanate (TDI). Examples of MDI can include, but are not limited to, monomeric MDI, polymeric MDI, and isomers thereof. Examples of isomers of MDI having the chemical formula C₁₅H₁₀N₂O₂ can include, but are not limited to, 2,2′-MDI, 2,4′-MDI, and 4,4′-MDI. Examples of isomers of TDI having the chemical formula C₉H₆N₂O₂ can include, but are not limited to, 2,4-TDI and 2,6-TDI. In certain embodiments, examples of isocyanates can include, but are not limited to, monomeric diisocyanates and blocked polyisocyanates. In certain embodiments, examples of monomeric diisocyanates can include, but are not limited to, hexamethylene diisocyanate (HI), methylene dicyclohexyl diisocyanate or hydrogenated MDI (HMDI), and isophorone diisocyanate (IPDI). In certain embodiments, an example of an HDI can be hexamethylene-1,6-diisocyanate. In certain embodiments, an example of an HMDI can be dicyclohexylmethane-4,4′-diisocyanate. Blocked polyisocyanates can be based on HDI or IDPI. In certain embodiments, examples of blocked polyisocyanates can include, but are not limited to, HDI trimer, HDI biuret, HDI uretidione, and IPDI trimer.

In certain embodiments, examples of isocyanates can include, but are not limited to, aromatic diisocyanates, such as a mixture of 2,4- and 2,6-tolylene diisocyanates (TDI), diphenylmethane-4,4′-diisocyanate (MDI), naphthalene-1,5-diisocyanate (NDI), 3,3′-dimethyl-4,4′-biphenylene diisocyanate (TODI), crude TDI, polymethylenepolyphenyl isocyanurate, crude MDI, xylylene diisocyanate (XDI), and phenylene diisocyanate; aliphatic diisocyanates, such as 4,4′-methylene-biscyclohexyl diisocyanate (hydrogenated MIDI), hexamethylene diisocyanate (HMDI), isophorone diisocyanate (IPDI), and cyclohexane diisocyanate (hydrogenated XDI); and modified products thereof, such as isocyanurates, carbodiimides and allophanamides.

In certain embodiments, a compound having terminal hydroxyl groups (R—(OH)ₙ), where n is at least 2 (referred to herein as “di-functional”), at least 3 (referred to herein as “tri-functional”), at least 4, at least 5, at least 6, at least 7, at least 8, at least 9, and 10, where R is an aliphatic and/or cyclic group, can be a “polyol.” In certain embodiments a polyol mixture can include a small amount of mono-functional compounds having a single terminal hydroxyl group.

In certain embodiments, examples of polyols can include, but are not limited to, polyester polyols and polyether polyols. In certain embodiments, examples of polyester polyols can include, but are not limited to, those built from condensation of acids and alcohols. In certain embodiments, examples can include those built from phthalic anhydride and diethylene glyol, phthalic anhydride and dipropylene glycol, adipic acid and butanediol, and succinic acid and butane or hexanediol. In certain embodiments, polyester polyols can be semi-crystalline. In certain embodiments, examples of polyether polyols can include, but are not limited to, those built from polymerization of an oxide such as ethylene oxide, propylene oxide, or butylene oxide from an initiator such as glycerol, dipropylene glycol, TPG (tripropylene glycol), castor oil, sucrose, or sorbitol.

In certain embodiments, examples of polyols can include, but are not limited to, polycarbonate polyols and lactone polyols such as polycaprolactone. In certain embodiments, a compound having terminal hydroxyl groups (R—(OH)ₙ) can have a molecular weight (calculated before incorporation of the compound having terminal hydroxyl groups into a polymer) of from about 200 Daltons to about 20,000 Daltons, such as from about 200 Daltons to about 10,000 Daltons.

In certain embodiments, a compound having terminal amine groups (e.g., R—(N(R′)₂)ₙ), where n can be at least 2, at least 3, at least 4, at least 5, at least 6, at least 7, at least 8, at least 9, and 10, where R can be an aliphatic and/or cyclic group, and where each R′ can be independently hydrogen or an aliphatic and/or cyclic group (e.g., a. (C₁-C₄)alkyl group), can be referred to as a “poly amine.” In certain embodiments, a polyamine mixture can include a small amount of mono-functional compounds having a single terminal amine group.

In certain embodiments, a suitable polyamine can be a diamine or triamine, and can be either a primary or secondary amine. In certain embodiments, a compound having terminal amine groups can have a molecular weight (calculated before incorporation of the compound having terminal hydroxyl groups into a polymer) of from about 30 Daltons to about 5000 Daltons, such as from about 40 Daltons to about 400 Daltons.

In certain embodiments, examples of polyamines can include, but are not limited to, diethyltoluene diamine, di-(methylthio)toluene diamine, 4,4′-methylenebis(2-chloroaniline), and chain extenders available under the trade names LONZACURE L15, LONZACURE M-CDEA, LONZACURE M-DEA, LONZACURE M-DIPA, LOINZACURE M-MIPA, and LONZACURE DETIDA.

In certain embodiments, examples of suitable polyamines can include, but are not limited to, ethylene diamine, 1,2-diaminopropane, 1,4-diaminobutane, 1,3-diaminopentane, 1,6-diaminohexane, 2,5-diamino-2,5-dimethylhexane, 2,2,4- and/or 2,4,4-trimethyl-1,6-dianminohexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluylene diamine, 2,4′ and/or 4,4′-diaminodicyclohexyl methane, and 3,3′-dialkyl-4,4′-diamino-dicyclohexyl methanes such as 3,3′-dimethyl-4,4-diamino-dicyclohexyl methane and 3,3′-diethyl-4,4′-diaminodicyclohexyl methane; aromatic polyamines such as 2,4- and/or 2,6-diaminotoluene and 2,4′ and/or 4,4′-diaminodiphenyl methane; and polyoxyalkylene polyamines.

In certain embodiments, the term polyol and/or polyamine mixture can be a mixture of one or more polyols of varied molecular weights and functionalities, one or more polyamines of varied molecular weights and functionalities, or a combination of one or more polyols and one or more polyamines.

In certain embodiments, the present disclosure also provides the compositions described herein and a thermoset system comprising the compositions, e.g., a first reactive component and a second reactive component, and one or more optional reactive components, such as a third reactive component.

In certain embodiments, the thermosetting material can comprise at least one reactive component. In certain embodiments, the thermosetting material can comprise at least two reactive components. In certain embodiments, the thermosetting material can comprise at least three reactive components. In certain embodiments, the thermosetting material can comprise at least four reactive components.

In certain embodiments, the thermosetting material can be prepared by methods disclosed in WO 2018/106822 and PCT/US2018/064323, each of which is incorporated in its entirety herein. In certain embodiments, a method for making a thermosetting material, such as a urethane and/or urea-containing polymer thermoset product, can include introducing first and second reactive components into a mixing chamber. In certain embodiments, the first reactive component can include an isocyanate and the second reactive component can include a polyol and/or polyamine mixture. In certain embodiments, the first reactive component can include an isocyanate and the second reactive component can include a polyol. In certain embodiments, the first reactive component can include an isocyanate and the second reactive component can include a polyamine. In certain embodiments, the first reactive component can include an isocyanate and the second reactive component can include a polyol and a polyamine. The first and second reactive components can have certain characteristics including, but not limited to, viscosity, reactivity, and chemical compatibility.

In certain embodiments, the thermosetting material can be a solid thermosetting material.

In certain embodiments, the thermosetting material can be a foam thermosetting material.

In certain embodiments, the thermosetting material can be a solid thermosetting material and a foam thermosetting material.

With respect to foams, numerous applications are envisioned, including orthotics, prosthetics, footware, grips, seals, gaskets, sound barriers, shock absorption, prosthetic joints, among many others. Products with varied foam properties can be particularly advantageous. For example, informed by pressure-mapping, mattresses can be fabricated to provide ideal support for an individual's weight distribution and preferred sleeping position. Vibration dampening foams can be designed with varied cellular structure and material elasticity to dampen a broad spectrum of vibrations with a minimum amount of material Space-efficient seating can be built for furnishings or transportation. Energy absorbing safety helmets can be designed with a higher level of comfort and fit. Foam padding can be designed for medical applications (such as wheel chair seating) with conforming fit and reduced pressure points to reduce the incidence of pressure-induced skin ulcers. Areas with open-cell structures can be placed within a structure of closed-cell structures to preferentially channel the flow of air of liquids through the part.

While the following description is in the context of foams, the description can apply to thermosetting materials, including urethane and/or urea-containing polymers in general, both non-foam and foam. Foams are available in a range of hardness and resiliencies. A urethane and/or urea-containing polymer can be very durable, permitting the foam to be used repeatedly without a change in properties. This range of properties permits these materials to be used in clinical settings where rigid positioning is desirable or where pressure distribution is more desirable.

Foams of urethane and/or urea-containing polymers can be the product of a reaction between two reactant components. A range of foam properties can be achieved by altering the relative weights of formulation components to balance reaction speed, interfacial tension of the reacting mixture, and elasticity of the polymeric scaffold. In 3D printing, an extrusion nozzle can deposit material, e.g., thermosetting material, on a substrate layer by layer, following a 3D computer model of the desired 3D object.

In certain embodiments, foam precursor formulas can enable high resolution 3D deposition to form a custom 3D foam object. In certain embodiments, by partially advancing the reaction of the precursors, such as polyurethane precursors, and adjusting catalyst and surfactant levels, it is possible to deposit the thermosetting material while maintaining the desired predetermined part resolution and mechanical integrity of the foam.

The production of a foam of urethane and/or urea-containing polymers can differ from the production of a non-foam urethane and/or urea-containing polymer by the inclusion of water. Foams of urethane and/or urea-containing polymer can be formed by the simultaneous reaction of isocyanates with water to form urea linkages and produce gas, and the reaction of isocyanates with multifunctional high molecular weight alcohols to form a crosslinked elastomeric foam scaffold.

In certain embodiments, foams can be formed by reacting monomers: a di-isocyanate, water, and multi-functional alcohol (e.g., a polyol) or a multi-functional amine. The quantity of water in the formula can affect the foam density and the strength of the foam scaffold. The molecular weight of the polyol and/or polyamine mixture can determine the crosslink density of the foam scaffold and the resulting elasticity, resiliency, and hardness of the foam. In certain embodiments, a nearly stoichiometric quantity of di-isocyanate can be used to fully react with the water and a polyol and/or polyamine mixture.

In certain embodiments, prepolymer synthesis can be used to alter the cure profile of a polyurethane or polyurea system. In prepolymer synthesis, a stoichiometric excess of di-isocyanate can be reacted with a polyol and/or polyamine mixture. The resulting prepolymer can have a higher molecular weight than the starting di-isocyanate, and molecules in the pre-polymer can have isocyanate functionality and therefore still be reactive. Because of the higher molecular weight, hydrogen bonding, and/or urea linkages, the prepolymer can also have a higher viscosity. This prepolymer can be subsequently reacted with a polyol and/or polyamine mixture and water to produce a foam with substantially the same foam scaffold composition that is achievable without prepolymer synthesis. However, viscosity growth profile can be altered, typically starting higher, and increasing more slowly, and therefore the morphological features of the foam, such as foam cell size and cell stability, can result in a foam with a very different appearance.

Support foams are not a single density, hardness, or resilience, but can span a wide range of performance. The present disclosure extends the entire range of foam properties. Foam density and hardness can be interrelated: low density foams can be softer foams. A range of foam density and hardness can be achieved first by varying the level of blowing agent, such as water, in the formulation and by adjusting the extent of excess isocyanate in the formula. Increasing the degree of functionality of the components of the polyol and/or polyamine mixture (e.g., incorporating some 4- or 6-functional polyols) can increase hardness and the viscosity growth rate during cure. Foam resilience can be altered by varying the polyols and/or polyamines incorporated in the formula. Memory foams can be achieved by reducing the molecular weight of the polyols and polyamines; high resiliency can be achieved by incorporating graft polyols. In certain embodiments, the foam density range can be less than 0.3 g/cm³, ranging from 30-50 ILFD hardness, and resilience ranging from 10 to 50%. Foam properties can also include open cell content and closed cell content. Open cell foams can be cellular structures built from struts, with windows in the cell walls which can permit flow of air or liquid between cells. Closed cells can be advantageous for preventing air flow, such as in insulation applications.

Prefabricated Article

The prefabricated article according to the present disclosure can be composed of any number of materials and the composition of the prefabricated article is not particularly limiting.

In certain embodiments, the prefabricated article can be a thermoplastic, a metal, a thermoset, a ceramic, a wood, a composite (i.e., a material made from two or more constituent materials), a carbon fiber, a Kevlar, a glass, and mixtures thereof. In certain embodiments, the prefabricated article can be a non-porous material or a porous material.

In certain embodiments, the prefabricated article can be a polyalkylene. In certain embodiments, the prefabricated article can be polyethylene, polypropylene, or polybutylene. In certain embodiments, the polyalkylene can contain a filler. In certain embodiments, the polyalkylene can contain glass. In certain embodiments, the prefabricated article can be polypropylene containing class. In certain embodiments, the prefabricated article can be 10% glass filled polypropylene.

In certain embodiments, the prefabricated article can have more than one material on its exterior before the depositing. As a non-limiting example, a portion of the exterior can be a thermoplastic and a portion of the exterior can be a metal.

In certain embodiments, a prefabricated article could include two or more of a thermoplastic, a metal, a thermoset, a ceramic, a wood, a composite, a carbon fiber, a Kevlar, a glass, and mixtures thereof. As a non-limiting example, the prefabricated article can be a thermoplastic that is covered, at least in part by, a metal. As a non-limiting example, the prefabricated article can be a ceramic that is covered, at least in part, by a composite.

In certain embodiments, the prefabricated article can be acrylonitrile-styrene-butadiene. In certain embodiments, the prefabricated article can be polycarbonate. In certain embodiments, the prefabricated article can be an acrylonitrile-styrene-butadiene/polycarbonate blend.

In certain embodiments, the prefabricated article can be a fabric. In certain embodiments, the prefabricated article can be a paper. In certain embodiments, the prefabricated article can be cardboard.

In certain embodiments, the prefabricated article can contain electronic components or electronic assemblies. In certain embodiments, the prefabricated article can have electronics or a circuit board.

In certain embodiments, the prefabricated article can contain optoelectronic components or optoelectronic assemblies.

In certain embodiments, the prefabricated article can contain a bond between the thermosetting material and the prefabricated article.

In certain embodiments, the bond can be an adhesive bond, a cohesive bond, a geometric bond, or a chemical bond.

In certain embodiments, there is a peel strength between the thermosetting material and the prefabricated article. In certain embodiments, the peel strength can be from about 0.01 N/mm to about 200 N/mm. In certain embodiments, the peel strength can be about 0.1 N/mm to about 100 N/mm. In certain embodiments, the peel strength can be from about 1 N/mm to about 20 N/mm. In certain embodiments, the peel strength can be from about 8 N/mm to about 20 N/mm. In certain embodiments, the peel strength can be about 1 N/mm to about 8 N/mm.

In certain embodiments, the peel strength can be about 0.01 N/mm, about 0.05 N/mm, about 0.1 N/mm about 0.5 N/mm, about 1 N/mm, about 2 N/mm, about 3 N/mm, about 4 N/mm, about 5 N/mm, about 6 N/mm, about 7 N/mm, about 8 N/mm, about 9 N/mm, about 10 N/mm, about 11 N/mm, about 12 N/mm, about 13 N/mm, about 14 N/mm, about 15 N/mm, about 16 N/mm, about 17 N/mm, about 18 N/mm, about 19 N/mm, about 20 N/mm, about 21 N/mm, about 22 N/mm, about 23 N/mm, about 24 N/mm, about 25 N/mm, about 50 N/mm, about 100 N/mm, about 200 N/mm, or any ranges between the specified values

In certain embodiments, the prefabricated article can be any number of shapes and the shape of the prefabricated article is not particularly limiting.

In certain embodiments, the prefabricated article can be any 3D shape. In certain embodiments, the prefabricated article can have an irregular shape, e.g., by having cavities, unequal dimensions, or asymmetrical shape. In certain embodiments, the prefabricated article can have a smooth shape.

In certain embodiments, the prefabricated article can be a 3D printed object. In certain embodiments, the prefabricated article can be an object that was not 3D printed.

In certain embodiments, the prefabricated article can be a polyhedron.

In certain embodiments, the prefabricated article can be a sphere, a tetrahedron, a triangular prism, a cylinder, a cone, a pyramid, a cuboid, a cube, and an octahedron.

Controller, Sensors, and Processors

In certain embodiments, the present disclosure includes a control system or a computing apparatus operably coupled to a printing apparatus.

The computing apparatus can be, for example, any fixed or mobile computer system (e.g., a controller, a microcontroller, a personal computer, minicomputer, etc.). The exact configuration of the computing apparatus is not limiting, and essentially any device capable of providing suitable computing capabilities and control capabilities can be used, a digital file can be any medium (e.g., volatile or non-volatile memory, a CD-ROM, magnetic recordable tape, etc.) containing digital bits (e.g., encoded in binary, etc.) that can be readable and/or writeable by computing apparatus. Also, a file in user-readable format can be any representation of data (e.g., ASCII text, binary numbers, hexadecimal numbers, decimal numbers, graphically, etc.) presentable on any medium (e.g., paper, a display, etc.) readable and/or understandable by an operator.

In certain embodiments, the control system can include one or more processors.

In certain embodiments, the system can the control system comprises one or more sensors. In certain embodiments, the one or more sensors can detect the location of the prefabricated article.

In certain embodiments, the one or more sensors can detect the location of the prefabricated article and optimize the depositing of the at least one layer of thermosetting material based on the shape and location of the prefabricated article

In certain embodiments, the controller can comprise one or more processors and can provide instructions to the extruded thermoset printing apparatus. These instructions can modify the method for printing a 3D printed object. In certain embodiments, these instructions instruct at least one actuator operably coupled to the extrusion nozzle to move the extrusion nozzle when delivering thermosetting material to form the 3D printed object.

In certain embodiments, a controller can analyze aspect ratio and deposit thermosetting material based on the aspect ratio of a bead. For example, the controller can instruct the 3D printer to print with a low aspect ratio/high viscosity bead for certain aspects of a 3D printed object and then the controller can instruct the 3D printer to print with a high aspect ratio/low viscosity bead for other aspects of a 3D printed object. This controlling of aspect ratio can provide a 3D printed object with high resolution, e.g., on the edges of a 3D object, and then use increased printing speeds to space fill aspects of a 3D object.

In certain embodiments, the controller can adjust one or both of the amount and flow rate of the thermosetting material to provide a physical property of a first area that is different than the same physical property of the second area. In certain embodiments, the physical property can be one or more of flexibility, color, optical refractive index, hardness, porosity, and density.

In certain embodiments, the controller can be configured to execute or the method further comprises adjusting one or both of an amount and a flow rate of a gas-generation source for use with one or more of a first, second, and third reactive components.

In certain embodiments, the controller can be configured to execute or the method further comprises controlling a distance between the extrusion nozzle and the prefabricated article.

### EXAMPLES

The methods and objects described herein are now further detailed with reference to the following examples. These examples are provided for the purpose of illustration only and the embodiments described herein should in no way be construed as being limited to these examples. Rather, the embodiments should be construed to encompass any and all variations which become evident as a result of the teaching provided herein.

### Example 1 Partial Encapsulation of a Metal Prefabricated Article

The 3D printing system was used to create a thermoset plastic part that partially encapsulated a pre-existing metal prefabricated article.

A 3D model of a thermoset plastic part containing a void in the shape of the metal prefabricated article was created using a traditional 3D CAD system. The model was then printed using a German RepRap x400 LAM 3D Printer using a ViscoDuo FDD liquid extruder.

Printing was started and initially followed a process for printing 2-part thermoset materials. After printing five layers, the printer was instructed to pause and a metal prefabricated article was placed onto the partially completed bottom section of the part; the printing platform system used features to facilitate accurate location analysis of the printed object. The printer was then instructed to resume printing and the part was completed by extruding the remaining layers onto the initially deposited layers and the metal prefabricated article.

The completed print resulted in a thermoset plastic part comprising a 3 mm thick shell encapsulating a portion of a metal prefabricated article with the ends of the sub-assembly extending from the part.

### Example 2 Complete Encapsulation of Multiple Composite Prefabricated Articles

The system was used to create a thermoset plastic part that completely encapsulated multiple pre-existing composite prefabricated articles.

A 3D model of a thermoset plastic part containing three voids in the shape of each of the composite prefabricated articles was created using a traditional 3D CAD system. The model was then printed using a German RepRap x400 LAM 3D Printer using a ViscoDuo FDD liquid extruder.

Printing was started and initially followed a process for printing 2-part thermoset materials. After printing seven layers, the printer was instructed to pause and each of the composite prefabricated articles was placed onto the partially completed bottom section of the part; the printing platform system used features to facilitate accurate location analysis of the printed object. The printer was then instructed to resume printing and the part was completed by extruding the remaining layers onto the initially deposited layers and the composite prefabricated articles.

The completed print resulted in a thermoset plastic part completely encapsulating three composite prefabricated articles.

### Example 3 Printing on a Prefabricated Article

The system was used to create a thermoset plastic part that is assembled on top of a prefabricated article.

A 3D model of a thermoset plastic part was created using a traditional 3D CAD system. The part used the shape of a prefabricated article as its base. The model was then printed using a German RepRap x400 LAM 3D Printer using a ViscoDuo FDD liquid extruder.

The prefabricated article was placed on the printing platform using a custom fixture to allow accurate positioning of the prefabricated article and subsequent printed part.

Printing followed a process for printing 2-part thermoset materials with the exception that the prefabricated article provided a base for the printed part.

The completed print resulted in a thermoset plastic part comprising a 2.5 mm thick gasket securely bonded to a plastic prefabricated article.

### Example 4 Encapsulating Electronic Prefabricated Articles

The system was used to create a thermoset plastic part that encapsulated metal prefabricated articles, including composite and electronic prefabricated articles.

A 3D model of a thermoset plastic part containing voids in the shape of prefabricated articles such as an electronic circuit board, wiring, and sensors were created using a traditional 3D CAD system. The model was printed using a German RepRap x400 LAM 3D Printer using a ViscoDuo FDD liquid extruder or a similar system capable of printing multi-part reactive materials.

Printing was started and initially followed a process for printing reactive thermoset materials. After printing a defined number of layers, the printer was instructed to pause and each of the prefabricated articles was placed onto the partially completed bottom section of the part; the printing platform system used features to facilitate accurate location analysis of the printed object. The printer was then instructed to resume printing and the part was completed by extruding the remaining layers onto the initially deposited layers and the prefabricated articles.

The completed print resulted in a thermoset plastic part encapsulating sensors, wiring, electronics, and other prefabricated articles. This provided a 3D printed object capable of creating a functioning device embedded structure and electronics.

### Example 5: Peel Strength and Force for 3D Printed Polyurethane

Polyurethane thermosetting material was deposited on black 10% glass filled polypropylene (PP) or on acrylonitrile-styrene-butadiene/polycarbonate blend (ABS/PC) sheets. Some substrates were plasma treated before the polyurethane was printed.

PP and ABS/PC sheets (9.8 cm square) were plasma treated by three different plasma treatment methods: chamber plasma treatment, atmospheric plasma treatment, and blown are plasma treatment. Blown arc plasma treatment included blowing atmospheric air past two high voltage power electrodes. Untreated PP and ABS/PC sheets were also prepared. Polyurethane strips were 3D printed onto the plasma treated sheets within 24 hours of the plasma treatment. The polyurethane strips were 1 cm wide and 12.7 cm long; 8.9 cm of the strip attached to the sheet leaving a 3.8 cm unattached tab. The polyurethane printed strips underwent a 90′ pull test using an MTS Insight electromechanical apparatus at a rate of 1.27 cm/minute.

The measurement for the plasma treated samples stopped at the point that the last bit of the strip was peeled from the sheet. The force used to start removal of the polyurethane was noted as the point when the slope of the force versus extension curve began to flatten or drop. The average force was calculated by taking all force measurements from the point the polyurethane began being removed, up to the point the polyurethane was completely removed from the sheet and averaging the values. Average force was used to calculate peel strength by dividing average force by the width of the polyurethane strips.

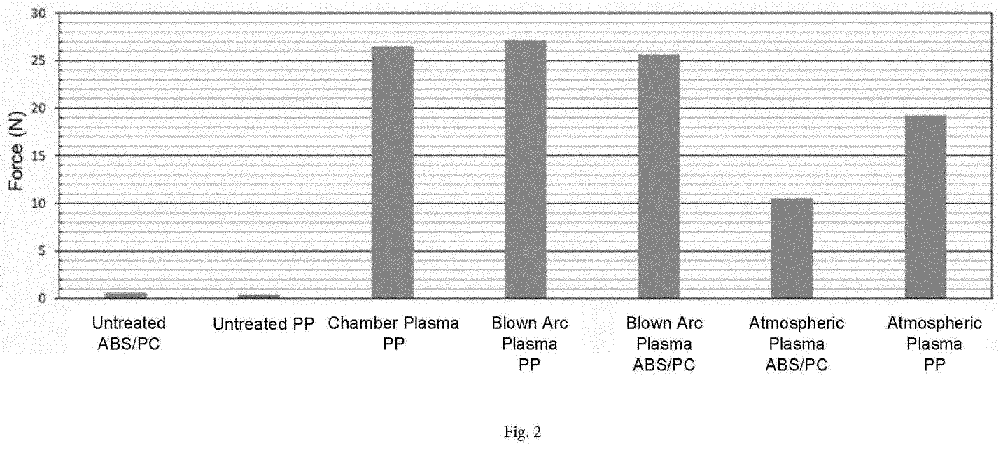

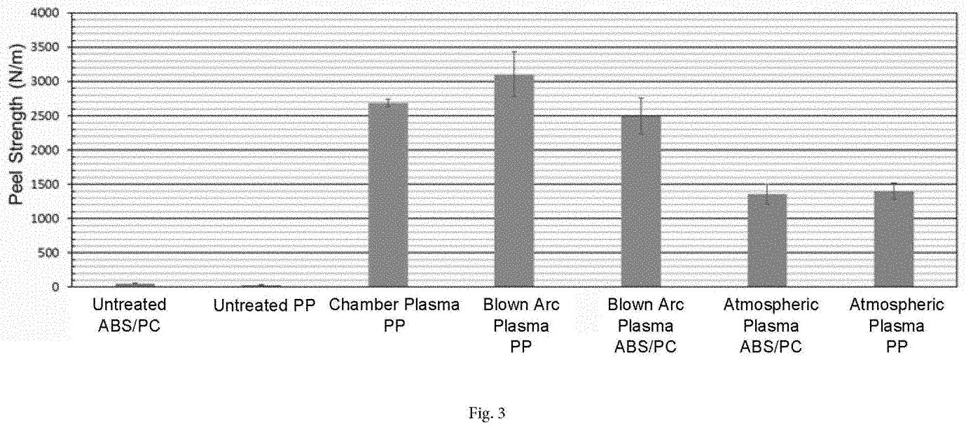

The polyurethane did not break in any of the tests. The results of the force tests are shown in FIG. 2 and the results of the peel strength tests are shown in FIG. 3. All samples demonstrated bonding between the prefabricated article substrate and the 3D printed polyurethane. The plasma treated samples demonstrated the highest peel strength.

### Example 6: Peel Strength for 3D Printed Polyurethane

Polyurethane thermosetting material was deposited on different materials. Four peel strips were printed. The strips were 127 mm long by 9 mm wide and were oriented with the strip length running in the X direction of the printer. The strips were filled using a linear pattern along the X direction with steps in the Y direction of 0.64 mm and a flow rate of 0.656 mm³/mm. The tip was 1.4 mm above the print surface. The two resin components were fed through a ViscoDuo FDD 4/4 extruder and through a Mixpac static mixer at a 1.1 index. One layer was printed

The wood, glass, cardboard, and ceramic were prepared by wiping the surface to remove any particles. The polylactic acid was printed in a sheet using an Ultimaker. Fabric types used were a metal fabric, Lycra, and a black leather-like fabric. The metal samples was carbon steel; one was untreated, one was oxidized, and the other was given an epoxy coating.

Samples were tested using an MTS Insight. The settings used for the test were as follows: Break Marker Drop 50%; Break Marker Elongation 0.1 in; Slack Pre-Load 1 lbf; Slope Segment Length 20%; Yield Offset 0.2%, Yield Segment Length 2%; Break Sensitivity 90%; Break Threshold 0.5 lbf; Data Acq. Rate 10 Hz; Test Speed 0.5 in/min.

Results of the peel strength testing are listed in Table 1.

TABLE 1
Peel Strength for 3D Printed Polyurethane

| | Peel Strength | Peel Strength Standard |
|---|---|---|
| Material | (N/m) | Deviation (N/m) |
| Wood | 969 | 2.9 |
| Glass | 1113 | 43.5 |
| Ceramic | 1410 | 33.2 |
| Fused Filament Fabrication | 2410^{A} | 195.9 |
| Polylactic Acid | | |
| Cast Urethane | >4000^{B} | N/A |
| Metal Fabric | >4000^{A} | N/A |
| Lycra Fabric | >4000^{A} | N/A |
| Black Fabric | >4000^{A} | N/A |
| Metal, No Treatment | 471 | 47.8 |
| Metal, Oxidized | 1248 | 49.4 |
| Metal, Epoxy Primer | N/A^{C} | N/A |
| Cardboard | >4000^{B} | N/A |

^{A}3D printed urethane failed before the 3D printed urethane peeled from substrate. Bond formed between 3D printed urethane and substrate was stronger than 3D printed urethane.
^{B}substrate failed before the 3D printed urethane peeled from substrate. Bond formed between the 3D printed urethane and substrate was stronger than substrate.
^{C}error occurred during 3D printing of urethane. Sample was no able to be tested for peel strength.

All samples demonstrated bonding between the prefabricated article substrate and the 3D printed polyurethane. For the metal fabric, Lycra fabric, and black fabric samples, the 3D printed urethane failed before the 3D printed urethane peeled from substrate (the bond formed between 3D printed urethane and substrate was stronger than the 3D printed urethane). For the fused filament fabrication polylactic acid, the 3D printed urethane failed before the 3D printed urethane peeled from substrate for 3 samples. For the cast urethane and cardboard samples, the substrate failed before the 3D printed urethane peeled from substrate (bond formed between the 3D printed urethane and substrate was stronger than substrate).

Embodiments of the disclosure demonstrated surprisingly strong peel strengths.

1. A method for additive manufacturing using a 3D printing apparatus, comprising:
providing at least one prefabricated article which forms at least a portion of a 3D printed object; and
depositing at least one layer of a thermosetting material on at least a portion of the prefabricated article according to a predefined pattern to form the 3D printed object.

2.-44. (canceled)

45. The method of claim 1, wherein at least a portion of a second layer of the thermosetting material is deposited on at least a portion of a first layer of the thermosetting material.

46. The method of claim 45, wherein at least a portion of a first layer is deposited on first portion of the prefabricated article, and at least a portion of another layer is deposited on a second portion of the prefabricated article different from the first portion of the prefabricated article.

47. The method of claim 1, further comprising:
a) depositing one or more initial layers of the thermosetting material on one or more portions of the prefabricated article;
b) stopping the deposition of thermosetting material for a period of time; followed by,
c) depositing one or more subsequent layers of the thermosetting material on one or more portions of the prefabricated article according to the predefined pattern.

48. The method of claim 47, wherein at least a portion of an initial layer of thermosetting material is deposited on a first portion of the prefabricated article, and at least a portion of a subsequent layer of the thermosetting material is deposited on a second portion of the prefabricated article different from the first portion of the prefabricated article.

49. The method of claim 1, wherein the prefabricated article comprises a polyhedron, a sphere, a tetrahedron, a triangular prism, a cylinder, a cone, a pyramid, a cuboid, a cube, an octahedron, a smooth shape, an irregular shape, or a combination thereof.

50. The method of claim 1, wherein the at least one prefabricated article comprises an electronic component, an optoelectronic component, a circuit board, or combinations thereof.

51. The method of claim 1, wherein the thermosetting material comprises an isocyanate, an isocyanate prepolymer, a urethane, a urea-containing polymer, a polyol prepolymer, an amine prepolymer, a polyol containing at least one terminal hydroxyl group, a polyamine containing at least one amine that contains an isocyanate reactive hydrogen, or combinations thereof.

52. The method of claim 1, wherein the thermosetting material is formed from at least two reactive components.

53. The method of claim 1, wherein the prefabricated article comprises a thermoplastic, a metal, a thermoset, a ceramic, wood, a composite, carbon fibers, Kevlar, glass, a circuit board, or any combination thereof.

54. The method of claim 1, wherein a bond is formed between at least one layer of the thermosetting material and at least a portion of the prefabricated article.

55. The method of claim 54, wherein the bond between the layer of the thermosetting material and the portion of the prefabricated article has a peel strength from about 0.01 N/mm to 200 N/mm, when determined at a pull angle of 900 at a rate of 1.27 cm/min.

56. The method of claim 54, wherein a surface of the provided prefabricated article has been pretreated using etching, acid etching, plasma etching, contacting with a chemically active solution, anodization, flame treatment, corona discharge, plasma treatment, atmospheric-pressure plasma treatment, low-pressure plasma treatment, blown arc plasma treatment, chamber plasma treatment, scraping, brushing, blasting, grinding, sandblasting, tumbling, pickling, abrading, power washing, electrodeposition coating, combustion chemical vapor deposition, passivation, laser pretreatment, UV pretreatment, ozone pretreatment, fluorooxidation, oxidation, or a combination thereof.

57. The method of claim 1, wherein the providing of the at least one prefabricated article comprises arranging at least one prefabricated article on top of at least one layer of deposited thermosetting material prior to the depositing of at least one additional layer of the thermosetting material on at least a portion of the prefabricated article.

58. The method of claim 1, further comprising determining a location of the provided prefabricated article using one or more sensors coupled to the 3D printing apparatus, and/or optimizing the depositing of the at least one layer of thermosetting material based on the shape and location of the prefabricated article.

59. A 3D printed object comprising at least one layer of a thermosetting material deposited by a 3D printing apparatus on at least a portion of at least one prefabricated article according to a predefined pattern.

60. The 3D printed object of claim 59, wherein at least a portion of the at least one prefabricated article is disposed between 2 or more layers of the thermosetting material.

61. The 3D printed object of claim 59, wherein at least a portion of the one or more layers of the thermosetting material is disposed between at least a portion of two surfaces of the at least one prefabricated article.

62. The 3D printed object of claim 59, wherein at least a portion of at least one layer of the thermosetting material is bonded to at least a portion of at least one prefabricated article.

63. The 3D printed object of claim 59, wherein the 3d printed object comprises deposited thermosetting material present as a solid, present a foam, or present as both a solid and a foam.
